(19) United States
(12) Patent Application Publication
(10) Pub. No.: US 2007/0175516 A1
(43) Pub. Date: Aug. 2, 2007

(54) Connecting structure for connecting a bulb holder with a connecting tube

(76) Inventor: Ming-Chi Tseng, Wufong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/342,810

(22) Filed: Jan. 31, 2006

(51) Int. Cl. F16K 15/20

(52) U.S. Cl. 137/231

(57) ABSTRACT

A connecting structure for connecting a bulb holder with a connecting tube, including a connecting tube, a fitting seat, a connecting seat and a bulb holder. The fitting seat is fitted in the connecting tube. The fitting seat has multiple male stopper sections and a first electric connection section. The connecting seat has a female stopper section, a fixing section and a second electric connection section. The female stopper section is engaged with the male stopper sections of the fitting seat. The second electric connecting section is electrically connected with the first electric connection section of the fitting seat. The bulb holder is fixedly connected with the fixing section of the connecting seat and electrically connected with the second electric connection section of the connecting seat.

### BACKGROUND OF THE INVENTION

The present invention is related to a connecting structure for connecting a bulb holder with a connecting tube. The connecting structure includes a fitting seat disposed in the connecting tube and a connecting seat fixedly connected with the bulb holder. The fitting seat can be quickly assembled with the connecting seat and disassembled from the connecting seat.

FIG. 10 shows a conventional connecting structure for connecting a bulb holder with a connecting tube of a ceiling lamp. A lower end of the connecting tube 91 is formed with an outer thread section 91. A threaded bush 93 is screwed on the outer thread section 91 to lock an outer shade 92 with the connecting tube 91. A lampshade 94 is further locked with the outer shade 92 by screws 921. A tube member 95 having outer thread is screwed in the threaded bush 93 to connect the threaded bush 93 with a fixing bracket 97. A nut 96 is screwed on the tube member 95 to locate the fixing bracket 97. A bulb holder 98 is locked under the fixing bracket 97, in which a bulb 99 is installed. A power cable 90 is conducted through the connecting tube 91, the threaded bush 93 and the tube member 95 to connect with the bulb holder.

The above connecting structure for connecting the bulb holder with the connecting tube has numerous components which are mainly connected with each other by screws. The manufacturing/assembling cost of such connecting structure is relatively high. In addition, the power cable is undetachably soldered when assembling the components. After assembled, the assembly has a considerably large volume, which necessitates more package material for packaging the product. Therefore, the packaging cost is also higher.

### SUMMARY OF THE INVENTION

It is therefore a primary object of the present invention to provide a connecting structure for connecting a bulb holder with a connecting tube. The connecting structure includes a fitting seat disposed in the connecting tube and a connecting seat fixedly connected with the bulb holder. The fitting seat can be quickly assembled with the connecting seat and disassembled from the connecting seat.

According to the above object, the connecting structure for connecting the bulb holder with the connecting tube includes a connecting tube, a fitting seat, a connecting seat and a bulb holder. The fitting seat is fitted in the connecting tube. A first end of the fitting seat is formed with multiple male stopper sections. A second end of the fitting seat has a first electric connection section. One end of the first electric connection section is connected with a power source. A first end of the connecting seat is formed with a female stopper section. A second end of the connecting seat has a fixing section. The connecting seat further has a second electric connection section. The female stopper section is engaged with the male stopper sections of the fitting seat. The second electric connecting section is electrically connected with the first electric connection section of the fitting seat. One end of the bulb holder is fixedly connected with the fixing section of the connecting seat and electrically connected with the second electric connection section of the connecting seat.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional assembled view of the first embodiment of the present invention in one state;

FIG. 3 is a sectional assembled view of the first embodiment of the present invention in another state;

FIG. 4 is a perspective sectional view of the male stopper section of the first embodiment of the present invention;

FIG. 5 is a perspective exploded view of a second embodiment of the present invention;

FIG. 6 is a sectional assembled view of the second embodiment of the present invention;

FIG. 7 is a perspective exploded view of the fitting seat of the second embodiment of the present invention;

FIG. 8 is a sectional view of the fitting seat of the second embodiment of the present invention;

FIG. 9 is a sectional view of the second embodiment of the present invention, showing that the press section of the male stopper section is pressed to separate the bulb holder from the connecting tube; and

FIG. 10 is a sectional view of a conventional connecting structure for connecting a bulb holder with a connecting tube of a ceiling lamp.

### DETAILED DESCRIPTION OF THE PREFERRED EMBODIMENTS

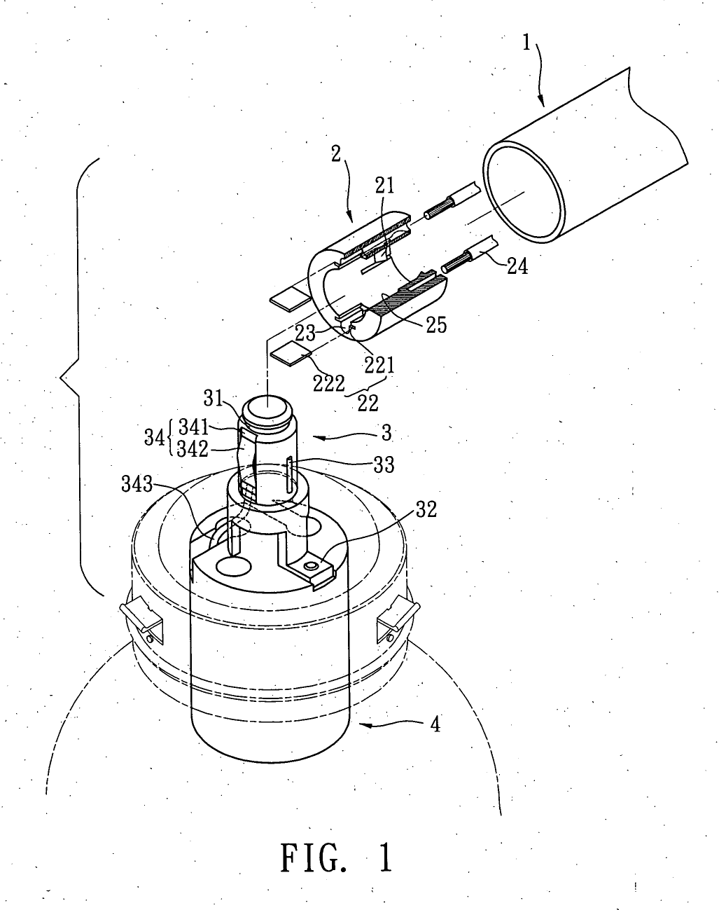

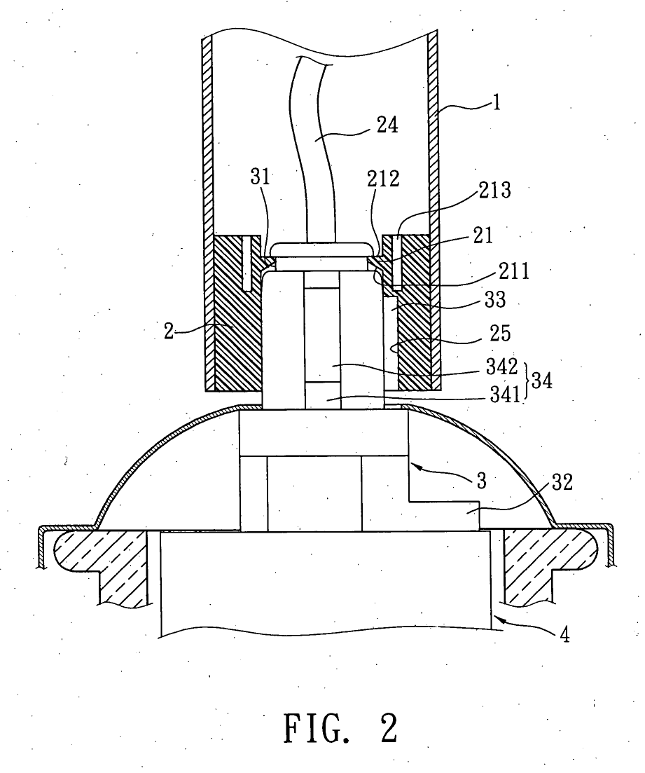

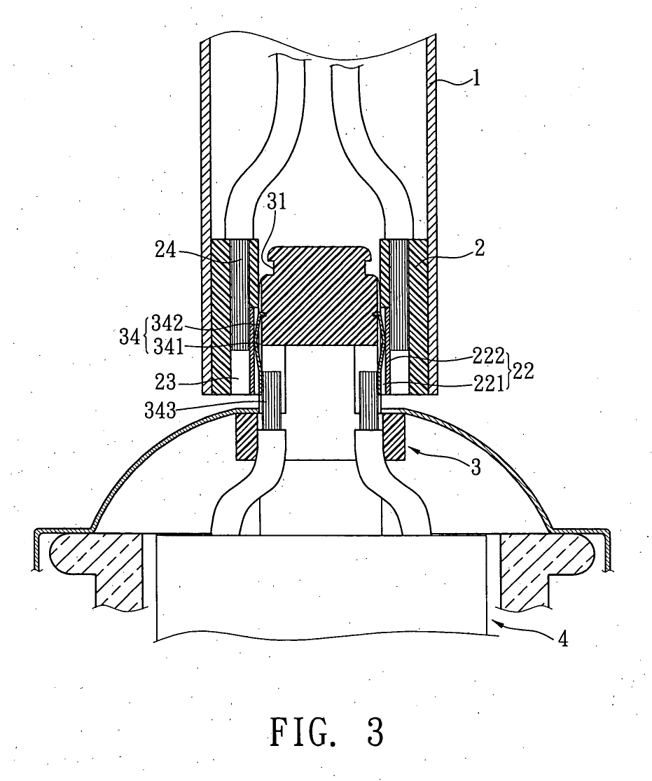

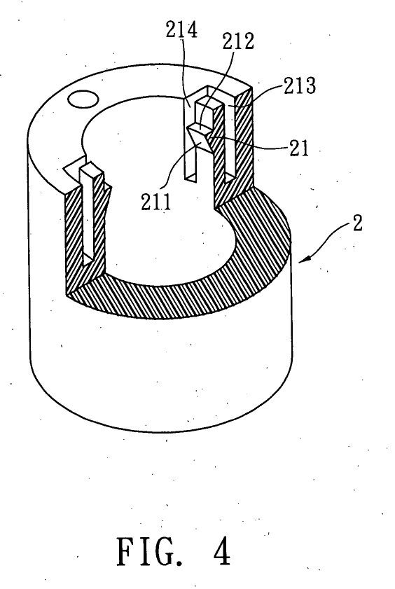

Please refer to FIGS. 1 to 4. The connecting structure for connecting a bulb holder with a connecting tube of the present invention includes a connecting tube 1, a fitting seat 2, a connecting seat 3 and a bulb holder 4. In this embodiment, the fitting seat 2 is a tubular member tightly fitted in the connecting tube 1. A first end of the fitting seat 2 is formed with multiple male stopper sections 21. A second end of the fitting seat 2 has a first electric connection section 22. Each male stopper section 21 is a stopper block having a guide face 211 and a stop face 212. A gap is defined between each male stopper section 21 and an outer wall of the fitting seat 2, permitting the male stopper section 21 to radially move. In addition, two sides of each male stopper section 21 are respectively spaced from an inner wall of the fitting seat 2 by two splits 214. The inner wall of the fitting seat 2 is formed with a locating trough 25. The first electric connection section 22 includes two grooves 221 formed on the inner wall of the fitting seat 2 and two conductive plates 222 respectively inlaid in the grooves 221. In addition, the wall of the fitting seat 2 is formed with two axial wire holes 23 communicating with the grooves 221. Two power wires 24 extend through the wire holes 23 to electrically connect with the conductive plates 222.

In this embodiment, a first end of the connecting seat 3 is formed with a female stopper section 31 which is an annular groove. The stopper blocks of the fitting seat 2 can be inlaid in the annular groove to engage the fitting seat 2 with the connecting seat 3. A second end of the connecting seat 3 has a fixing section 32. The bulb holder 4 is fixedly connected under the bottom end of the fixing section 32. A locating rib 33 is formed on a circumference of the connecting seat 3. The locating rib 33 can be inlaid in the locating trough 25 of the fitting seat 2 to prevent the fitting seat 2 from rotating. The connecting seat 3 has a second electric connection section 34 between the annular groove 31 and the fixing section 32. In this embodiment, the second electric connection section 34 includes two dents 341 and two conductive leaf springs 342 respectively mounted in the dents 341. The conductive leaf springs 342 respectively electrically contact with the conductive plates 222 and connect with the bulb holder 4 via two wires 343.

According to the above arrangement, when assembling the bulb holder with the connecting tube, the locating rib 33 of the connecting seat 3 is first aimed at and inlaid into the locating trough 25 of the fitting seat 2 to prevent the fitting seat 2 from rotating. The top end of the connecting seat 3 abuts against and outward stretches the stopper blocks of the fitting seat 2, whereby the stopper blocks can enter the annular groove of the connecting seat 3 to engage the fitting seat with the connecting seat. Under such circumstance, the stopper blocks prevent the fitting seat from being extracted out of the connecting seat. In addition, the power can be transmitted from the conductive plates 222 of the fitting seat 2 to the conductive leaf springs 342 of the connecting seat 3.

When the fitting seat 2 is forcedly drawn in reverse direction, the stopper blocks of the fitting seat 2 are stretched outward by the circumference of the top end of the connecting seat 3, whereby the bulb holder 4 can be quickly detached from the connecting tube 1. Accordingly, when packaged, the bulb holder 4 and the connecting tube 1 can be disassembled to minify the volume and reduce the package material. The connecting structure is simplified so that the manufacturing/assembling cost is lowered.

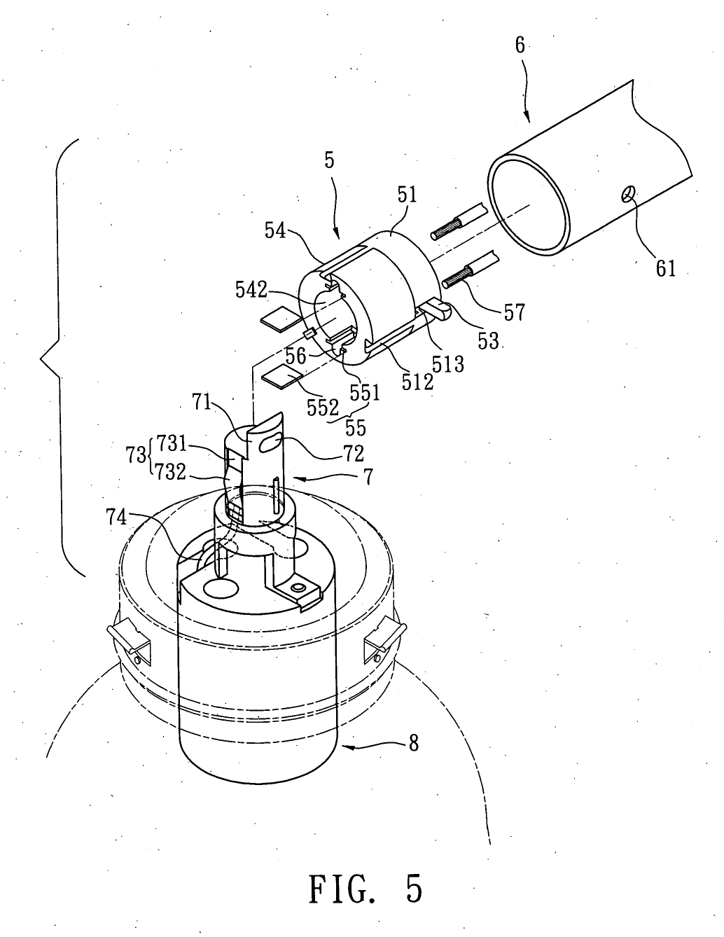

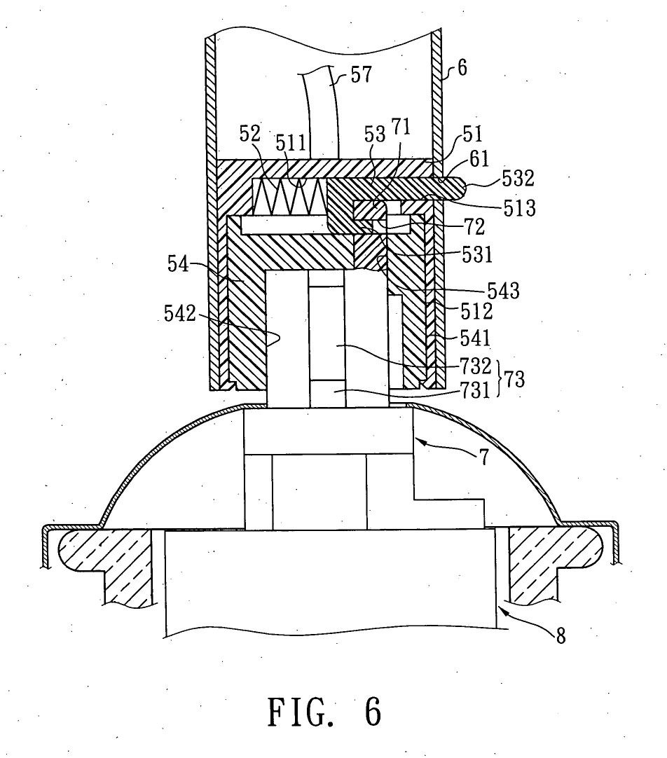

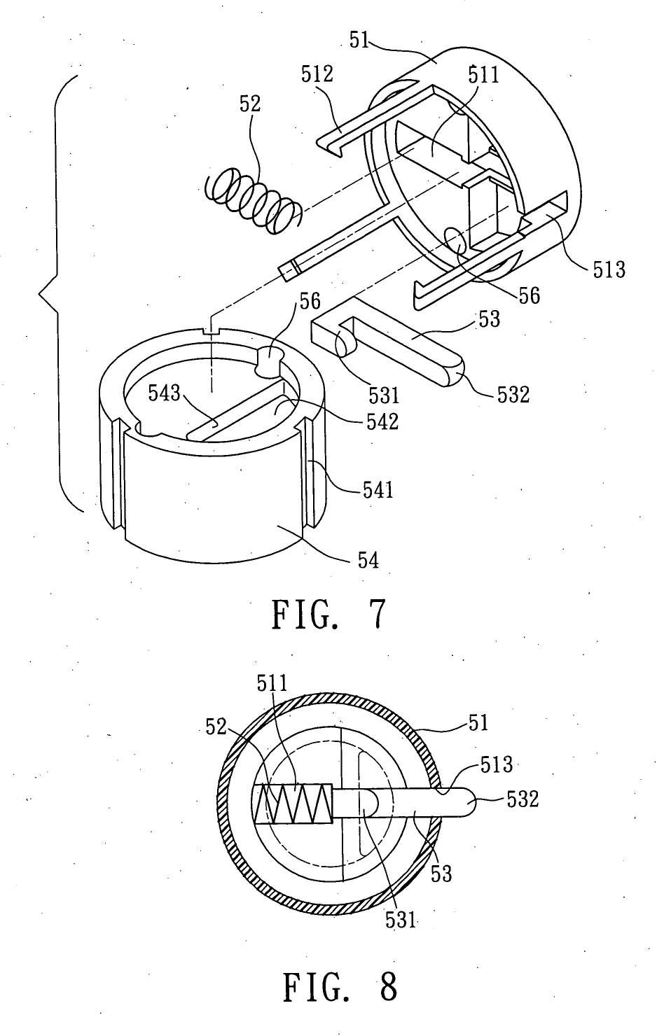

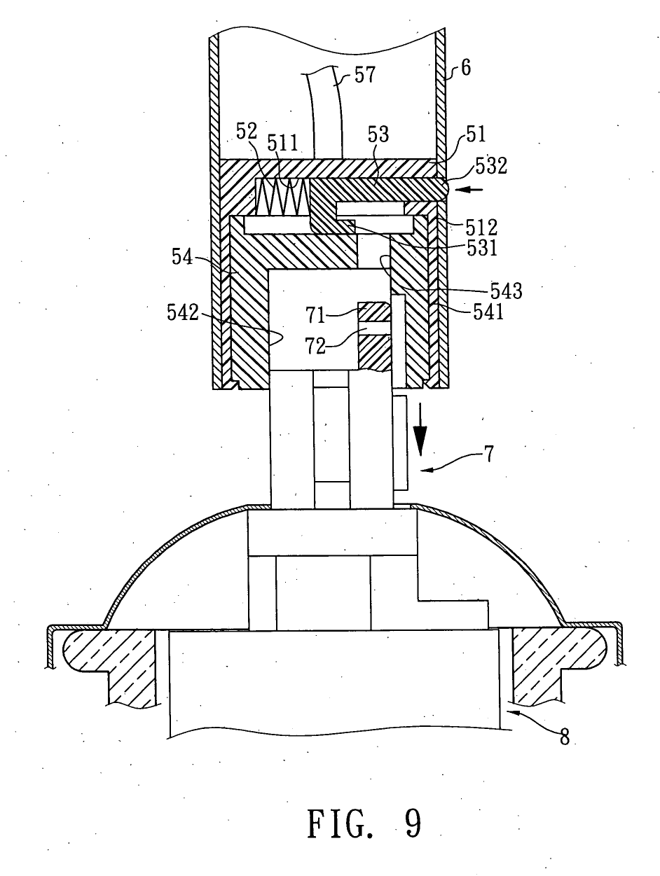

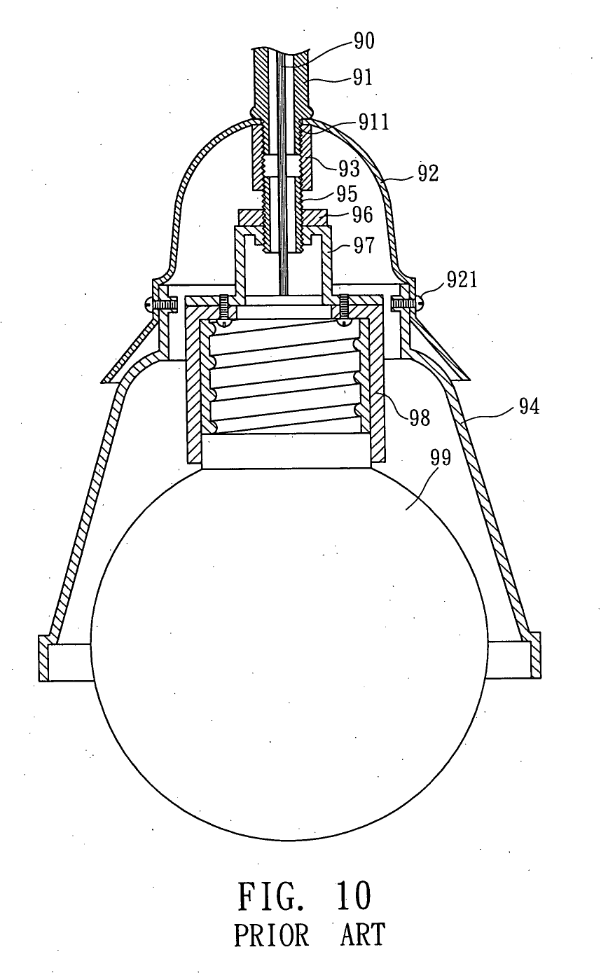

FIGS. 5 to 9 show a second embodiment of the present invention, in which a first end of the fitting seat 5 has an upper seat 51, a compression spring 52 and a male stopper section 53. One end of the male stopper section 53 has a stopper section 531, while the other end of the male stopper section 53 has a press section 532. One face of the upper seat 51 is formed with a cavity 511 facing the first electric connection section 55. Multiple hook arms 512 extend from the upper seat 51. A through hole 513 radially outward extends from the cavity 511. The connecting tube 6 has a through hole 61 corresponding to the through hole 513. The compression spring 52 is disposed in the cavity 511 to abut against the stopper section 531 of the male stopper section 53. The press section 532 of the male stopper section 53 passes through the through hole 513 of the cavity 511 and the through hole 61 of the connecting tube 6 and protrudes from the connecting tube 6.

The first electric connection section 55 is disposed on a base seat 54. The base seat 54 is formed with multiple channels 541 corresponding to the hook arms 512 of the upper seat 51. The hook arms 512 can extend through the channels 541 to latch with a bottom end of the base seat 54. In addition, one face of the base seat 54 is formed with a socket 542 distal from the upper seat 51. A through hole 543 is formed between the socket 542 and the cavity 511 of the upper seat 51. The wall face of the socket 542 is formed with two grooves 551 in which two conductive plates 552 are respectively inlaid. The upper seat 51 and the base seat 54 are formed with two axial wire holes 56 communicating with the grooves 551. Two power wires 57 extend through the wire holes 56 to electrically connect with the conductive plates 552.

The connecting seat 7 has a female stopper section 71 which is a projecting block formed with a radial insertion hole 72. The projecting block extends through the through hole 543 of the base seat 54. The stopper section 531 of the male stopper section 53 is fitted in the insertion hole 72 to engage with the female stopper section 71. The second electric connection section 73 of the connecting seat 7 includes two dents 731 and two conductive leaf springs 732 respectively mounted in the dents 731. The conductive leaf springs 732 respectively electrically contact with the conductive plates 552 of the fitting seat 5 and connect with the bulb holder 8 via two wires 74.

When assembled, the projecting block of the connecting seat 7 is first fitted into the through hole 543 of the base seat 54. At this time, the top end of the projecting block abuts against the stopper section 531 of the male stopper section 53. By means of pressing the press section 532, the compression spring 52 is compressed and the stopper section 531 is retreated, permitting the projecting block to further move upward. Then the press section 532 is released and the compression spring 52 is restored to make the stopper section 531 extend into the insertion hole 72 of the projecting block. When disassembled, the press section 532 of the male stopper section 53 is pressed to compress the compression spring 52. At this time, the stopper section 531 is retreated and extracted out of the insertion hole 72 of the connecting seat 7. Under such circumstance, the bulb holder 8 can be quickly detached from the connecting tube 6.

The above embodiments are only used to illustrate the present invention, not intended to limit the scope thereof. Many modifications of the above embodiments can be made without departing from the spirit of the present invention.

What is claimed is:

1. A connecting structure for connecting a bulb holder with a connecting tube, comprising a connecting tube, a fitting seat, a connecting seat and a bulb holder, the fitting seat being fitted in the connecting tube, a first end of the fitting seat being formed with multiple male stopper sections, a second end of the fitting seat having a first electric connection section, one end of the first electric connection section being connected with a power source, a first end of the connecting seat being formed with a female stopper section, a second end of the connecting seat having a fixing section, the connecting seat further having a second electric connection section, the female stopper section being engaged with the male stopper sections of the fitting seat, the second electric connecting section being electrically connected with the first electric connection section of the fitting seat, one end of the bulb holder being fixedly connected with the fixing section of the connecting seat and electrically connected with the second electric connection section of the connecting seat.

2. The connecting structure for connecting the bulb holder with the connecting tube as claimed in claim 1, wherein the fitting seat is a tubular member, each male stopper section being a stopper block having a guide face and a stop face, a gap being defined between each male stopper section and an outer wall of the fitting seat, permitting the male stopper section to radially move, two sides of each male stopper section being respectively spaced from an inner wall of the fitting seat by two splits, the inner wall of the fitting seat being formed with a locating trough, the first electric connection section including two grooves formed on the inner wall of the fitting seat and two conductive plates respectively inlaid in the grooves, the wall of the fitting seat being formed with two axial wire holes communicating with the grooves, whereby power wires extend through the wire holes to electrically connect with the conductive plates.

3. The connecting structure for connecting the bulb holder with the connecting tube as claimed in claim 2, wherein the female stopper section is an annular groove, the stopper blocks of the fitting seat being inlaid in the annular groove to engage the fitting seat with the connecting seat, a locating rib being formed on a circumference of the connecting seat, the locating rib being inlaid in the locating trough of the fitting seat to prevent the fitting seat from rotating, the second electric connection section including two dents and two conductive leaf springs respectively mounted in the dents, the conductive leaf springs respectively electrically contacting with the conductive plates of the fitting seat and connecting with the bulb holder via two wires.

4. The connecting structure for connecting the bulb holder with the connecting tube as claimed in claim 1, wherein a first end of the fitting seat has an upper seat, a compression spring and a male stopper section, one end of the male stopper section having a stopper section, while the other end of the male stopper section having a press section, one face of the upper seat being formed with a cavity facing the first electric connection section, multiple hook arms extending from the upper seat, a through hole radially outward extending from the cavity, the connecting tube having a through hole corresponding to the through hole of the cavity, the compression spring being disposed in the cavity to abut against the stopper section of the male stopper section, the press section of the male stopper section passing through the through hole of the cavity and the through hole of the connecting tube to protrudes from the connecting tube, the first electric connection section being disposed on a base seat, the base seat being formed with multiple channels corresponding to the hook arms of the upper seat, whereby the hook arms extend through the channels to latch with a bottom end of the base seat, one face of the base seat being formed with a socket distal from the upper seat, a through hole being formed between the socket and the cavity of the upper seat, a wall face of the socket being formed with two grooves in which two conductive plates are respectively inlaid, the upper seat and the base seat being formed with two axial wire holes communicating with the grooves, two power wires extending through the wire holes to electrically connect with the conductive plates.

5. The connecting structure for connecting the bulb holder with the connecting tube as claimed in claim 4, wherein the female stopper section of the connecting seat is a projecting block formed with a radial insertion hole, the projecting block extending through the through hole of the base seat, the stopper section of the male stopper section being fitted in the insertion hole to engage with the female stopper section, the second electric connection section of the connecting seat including two dents and two conductive leaf springs respectively mounted in the dents, the conductive leaf springs respectively electrically contacting with the conductive plates of the fitting seat and connecting with the bulb holder via two wires.
